(19) United States
(12) Patent Application Publication
(10) Pub. No.: US 2023/0004607 A1
(43) Pub. Date: Jan. 5, 2023

(54) KNOWLEDGE CONTENT DISTRIBUTION METHOD, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Ziyuan ZHAO, Beijing (CN); Shichen SHAO, Beijing (CN); Shouxun WANG, Beijing (CN)

(73) Assignee: BEIJING BAIDU NETCOM SCIENCE TECHNOLOGY CO., LTD., Beijing (CN)

(21) Appl. No.: 17/807,703

(22) Filed: Jun. 17, 2022

(30) Foreign Application Priority Data
Jun. 30, 2021 (CN) 202110739423.5

(51) Int. Cl. G06F 16/9535; G06F 16/9538

(52) U.S. Cl. CPC G06F 16/9535; G06F 16/9538

(57) ABSTRACT

Provided are a knowledge content distribution method, an electronic device, and a storage medium. The method includes the following. An acquisition request sent by a distribution waiting user for target knowledge content is received, where the acquisition request carries at least an identifier of the target knowledge content. In response to the acquisition request, the target knowledge content is acquired according to the priority of each author of the target knowledge content in terms of the target knowledge content. The target knowledge content is distributed to the distribution waiting user.

### CROSS-REFERENCE TO RELATED APPLICATION

This application claims priority to Chinese Patent Application No. 202110739423.5 filed on Jun. 30, 2021, the disclosure of which is incorporated herein by reference in its entirety.

### TECHNICAL FIELD

The present disclosure relates to the field of Internet technology, particularly to the field of knowledge sharing, and specifically to a knowledge content distribution method and apparatus, an electronic device, and a storage medium.

### BACKGROUND

With an increasingly large amount of online knowledge content, an author may produce high-quality knowledge content, sell the knowledge content to a user having corresponding needs, and thus make a profit based on knowledge payment. However, the knowledge content distribution methods in the related art have shortcomings including no accurate distribution manner for connecting a user and an author who produces knowledge content, a relatively simple recommendation strategy, and sole dependence on natural distribution for an author acquiring traffic.

When a current user fails to find the required knowledge content, the author producing the knowledge content cannot make a profit based on the payment for the user browsing more knowledge content.

### SUMMARY

The present disclosure provides a knowledge content distribution method, an electronic device, and a storage medium.

In a first aspect, the present application provides a knowledge content distribution method. The method includes the steps below.

An acquisition request sent by a distribution waiting user for target knowledge content is received, where the acquisition request carries at least an identifier of the target knowledge content.

In response to the acquisition request, the target knowledge content is acquired according to the priority of each author of the target knowledge content in terms of the target knowledge content.

The target knowledge content is distributed to the distribution waiting user.

In a second aspect, embodiments of the present application provide an electronic device.

The electronic device includes at least one processor and a memory. The memory is configured to store one or more programs. The one or more programs are executed by the at least one processor to cause the at least one processor to implement the knowledge content distribution method according to any embodiment of the present application.

In a third aspect, embodiments of the present disclosure provide a non-transitory computer-readable storage medium which stores a computer program. The computer instructions are configured to cause a computer to perform the knowledge content distribution method according to any embodiment of the present application.

The technology of the present application solves technical problems of the knowledge content distribution methods in the related art, including no accurate and efficient distribution manner for connecting a user and an author producing knowledge, a relatively simple recommendation strategy, and sole dependence on natural distribution for an author acquiring traffic. The technical solutions in the present application provide an accurate and efficient distribution manner for connecting a user and an author producing knowledge to ensure that the user acquires the knowledge content of high quality and high correlation and that the author producing the knowledge makes the high profit.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the present solution and not to limit the present disclosure.

FIG. 1 is a first flowchart of a knowledge content distribution method according to an embodiment of the present disclosure.

FIG. 2 is a second flowchart of a knowledge content distribution method according to an embodiment of the present disclosure.

FIG. 3 is a third flowchart of a knowledge content distribution method according to an embodiment of the present disclosure.

FIG. 4 is a structure diagram illustrating a knowledge content distribution apparatus according to an embodiment of the present application.

FIG. 5 is a block diagram of an electronic device for performing a knowledge content distribution method according to an embodiment of the present disclosure.

### DETAILED DESCRIPTION

Example embodiments of the present disclosure, including details of embodiments of the present disclosure, are described hereinafter in conjunction with the drawings to facilitate understanding. The example embodiments are merely illustrative. Therefore, it will be appreciated by those of ordinary skill in the art that various changes and modifications may be made to the embodiments described herein without departing from the scope and spirit of the present disclosure. Similarly, description of well-known functions and constructions is omitted hereinafter for clarity and conciseness.

### Embodiment One

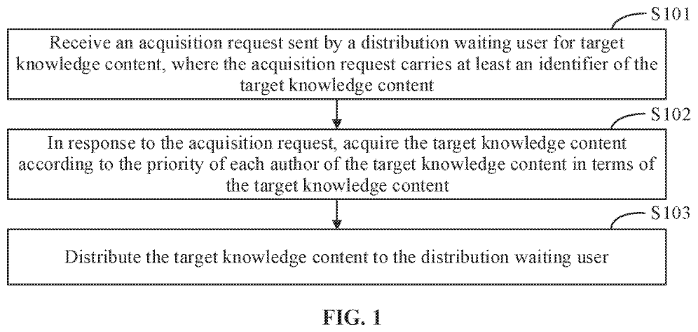

FIG. 1 is a flowchart of a knowledge content distribution method according to an embodiment of the present disclosure. The method may be performed by a knowledge content distribution apparatus or an electronic device. The apparatus or the electronic device may be implemented by software and/or hardware. The apparatus or the electronic device may be integrated into any intelligent device having a network communication function. As shown in FIG. 1, the knowledge content distribution method may include the steps below.

In S101, an acquisition request sent by a distribution waiting user for target knowledge content is received, where the acquisition request carries at least an identifier of the target knowledge content.

In this step, the electronic device receives an acquisition request sent by a distribution waiting user for target knowledge content, where the acquisition request carries at least an identifier of the target knowledge content. For example, the distribution waiting user enters the target knowledge content in a search box and then clicks the search button to send an acquisition request for the target knowledge content to the electronic device. The identifier of the target knowledge content in embodiments of the present application may be the name of the target knowledge content or other representation information of the target knowledge content.

In S102, in response to the acquisition request, the target knowledge content is acquired according to the priority of each author of the target knowledge content in terms of the target knowledge content.

In this step, in response to the acquisition request, the electronic device acquires the target knowledge content according to the priority of each author of the target knowledge content in terms of the target knowledge content. In an embodiment, the electronic device searches for the target knowledge content in the knowledge content database based on the identifier of the target knowledge content through a pre-trained knowledge content distribution model. In response to finding the target knowledge content produced by at least one author in the knowledge content database, the electronic device acquires the target knowledge content according to the priority of each author among the at least one author in terms of the target knowledge content.

In S103, the target knowledge content is distributed to the distribution waiting user.

In this step, the electronic device distributes the target knowledge content to the distribution waiting user. In an embodiment, the electronic device first sorts, according to the priority of each author of the target knowledge content in terms of the target knowledge content, target knowledge content produced by all authors, so as to obtain the sorted target knowledge content, and then displays the sorted target knowledge content to the distribution waiting user. For example, the electronic device gives priority to distributing the target knowledge content of an author with a higher priority to ensure that the author with a higher priority acquires more traffic and that the user acquires the knowledge content of higher quality and higher correlation.

In the knowledge content distribution method provided in embodiments of the present disclosure, an acquisition request sent by a distribution waiting user for target knowledge content is received first, where the acquisition request carries at least an identifier of the target knowledge content; then in response to the acquisition request, the target knowledge content is acquired according to the priority of each author of the target knowledge content in terms of the target knowledge content; and then the target knowledge content is distributed to the distribution waiting user. That is, in the present application, the target knowledge content is acquired according to the priority of each author of the target knowledge content in terms of the target knowledge content so that the acquired target knowledge content is distributed to the distribution waiting user. In comparison, in the existing content distribution methods, the manner of natural distribution is usually adopted without distinguishing different authors of the same knowledge content. The present application adopts the technical means of acquiring the target knowledge content according to the priority of each author of the target knowledge content in terms of the target knowledge content and thus overcomes technical problems of the knowledge content distribution methods in the related art, including no accurate and efficient distribution manner for connecting a user and an author producing knowledge, a relatively simple recommendation strategy, and sole dependence on natural distribution for an author acquiring traffic. Embodiments of the present application provide an accurate and efficient distribution manner for connecting a user and an author producing knowledge to ensure that the user acquires the knowledge content of high quality and high correlation and that the author producing the knowledge makes the high profit. Moreover, the technical solutions in embodiments of the present application are simply and conveniently implemented, easily popularized, and more widely applied.

### Embodiment Two

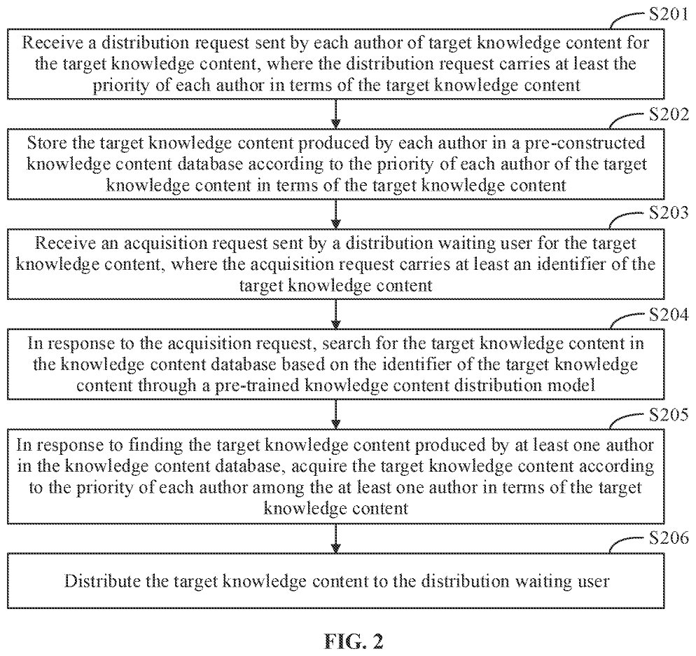

FIG. 2 is a second flowchart of a knowledge content distribution method according to an embodiment of the present disclosure. This embodiment is an optimization and expansion of the preceding technical solutions and can be combined with each preceding optional implementation. As shown in FIG. 2, the knowledge content distribution method may include the steps below.

In S201, a distribution request sent by each author of target knowledge content for the target knowledge content is received, where the distribution request carries at least the priority of each author in terms of the target knowledge content.

In this step, the electronic device receives a distribution request sent by each author of the target knowledge content for the target knowledge content, where the distribution request carries at least the priority of each author in terms of the target knowledge content. In an embodiment, the electronic device performs identification based on the distribution request so that the priority of each author in terms of the target knowledge content is identified in the distribution request. In a specific implementation, each author of the target knowledge content may also pay the distribution fee in advance to a knowledge content distribution platform. Then the knowledge content distribution platform determines the priority of each author in terms of the target knowledge content based on the distribution fee paid by each author. Moreover, the knowledge content distribution platform may also determine the priority of each author in terms of the target knowledge content based on factors including author levels, scores or VIP.

In S202, the target knowledge content produced by each author is stored in a pre-constructed knowledge content database according to the priority of each author of the target knowledge content in terms of the target knowledge content.

In this step, the electronic device stores the target knowledge content produced by each author in a pre-constructed knowledge content database according to the priority of each author of the target knowledge content in terms of the target knowledge content. In an embodiment, the electronic device sorts different authors of the same knowledge content according to the priority in advance and then stores the target knowledge content produced by each author in the pre-constructed knowledge content database according to the priority of each author of the target knowledge content in terms of the target knowledge content. In this case, the target knowledge content is distributed according to the priority of each author of the target knowledge content in terms of the target knowledge content so that an author with a higher priority makes a higher profit.

In S203, an acquisition request sent by a distribution waiting user for the target knowledge content is received, where the acquisition request carries at least an identifier of the target knowledge content.

In S204, in response to the acquisition request, the target knowledge content is searched for in the knowledge content database based on the identifier of the target knowledge content through a pre-trained knowledge content distribution model.

In this step, in response to the acquisition request, the electronic device searches for the target knowledge content in the knowledge content database based on the identifier of the target knowledge content through a pre-trained knowledge content distribution model. In an embodiment, the electronic device pre-trains the knowledge content distribution model and then searches for the target knowledge content in the knowledge content database based on the identifier of the target knowledge content through the pre-trained knowledge content distribution model. For example, the electronic device performs matching for each piece of knowledge content in the knowledge content database based on the identifier of the target knowledge content; and the knowledge content with the highest matching degree or the knowledge content with the matching degree in a predetermined range is taken as the target knowledge content.

In S205, in response to finding the target knowledge content produced by at least one author in the knowledge content database, the target knowledge content is acquired according to the priority of each author among the at least one author in terms of the target knowledge content.

In this step, in response to finding the target knowledge content produced by at least one author in the knowledge content database, the electronic device acquires the target knowledge content according to the priority of each author among the at least one author in terms of the target knowledge content. In an embodiment, in response to finding the target knowledge content produced by at least one author in the knowledge content database, the electronic device first determines the priority of each author among the at least one author and then acquires the target knowledge content according to the priority of each author in terms of the target knowledge content.

In S206, the target knowledge content is distributed to the distribution waiting user.

In embodiments of the present application, in response to the acquisition request sent by the distribution waiting user for the target knowledge content, the electronic device acquires the knowledge content associated with the target knowledge content according to the priority of each author of the target knowledge content in terms of the target knowledge content and then distributes the knowledge content associated with the target knowledge content to the distribution waiting user. In embodiments of the present application, the knowledge content associated with the target knowledge content may be the knowledge content in the same category as the target knowledge content or the knowledge content uploaded by a same author of target knowledge content, which is not limited here. The arrangement of distributing the associated knowledge content to the distribution waiting user helps raise choices for the distribution waiting user, provide other knowledge content that the user may be interested in, and increase the distribution profit for an author.

In the knowledge content distribution method provided in embodiments of the present disclosure, an acquisition request sent by a distribution waiting user for target knowledge content is received first, where the acquisition request carries at least an identifier of the target knowledge content; then in response to the acquisition request, the target knowledge content is acquired according to the priority of each author of the target knowledge content in terms of the target knowledge content; and then the target knowledge content is distributed to the distribution waiting user. That is, in the present application, the target knowledge content is acquired according to the priority of each author of the target knowledge content in terms of the target knowledge content so that the acquired target knowledge content is distributed to the distribution waiting user. In comparison, in the existing content distribution methods, the manner of natural distribution is usually adopted without distinguishing different authors of the same knowledge content. The present application adopts the technical means of acquiring the target knowledge content according to the priority of each author of the target knowledge content in terms of the target knowledge content and thus overcomes technical problems of the knowledge content distribution methods in the related art, including no accurate and efficient distribution manner for connecting a user and an author producing knowledge, a relatively simple recommendation strategy, and sole dependence on natural distribution for an author acquiring traffic. Embodiments of the present application provide an accurate and efficient distribution manner for connecting a user and an author producing knowledge to ensure that the user acquires the knowledge content of high quality and high correlation and that the author producing the knowledge makes the high profit. Moreover, the technical solutions in embodiments of the present application are simply and conveniently implemented, easily popularized, and more widely applied.

### Embodiment Three

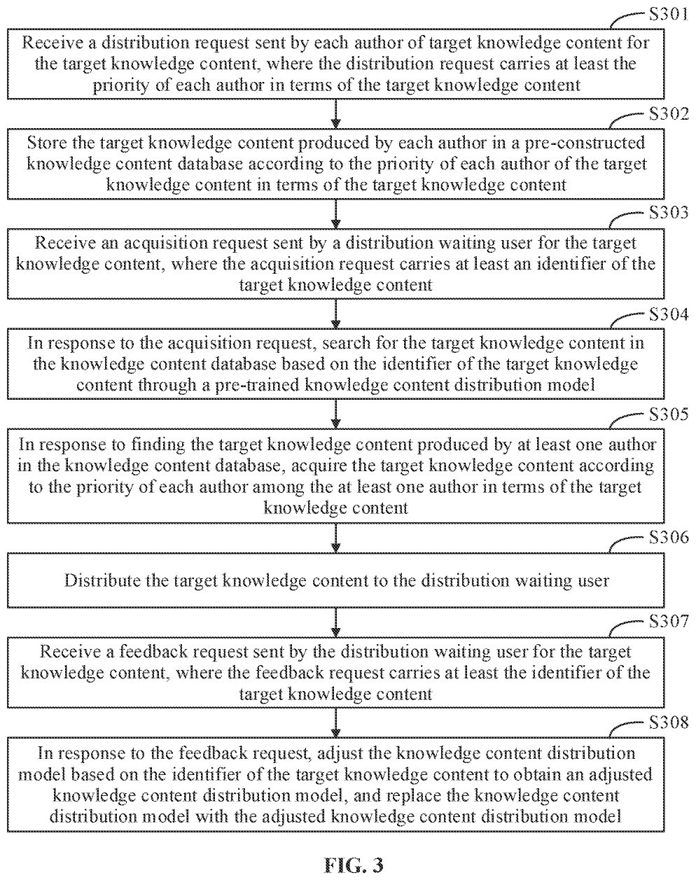

FIG. 3 is a third flowchart of a knowledge content distribution method according to an embodiment of the present disclosure. This embodiment is an optimization and expansion of the preceding technical solutions and can be combined with each preceding optional implementation. As shown in FIG. 3, the knowledge content distribution method may include the steps below.

In S301, a distribution request sent by each author of target knowledge content for the target knowledge content is received, where the distribution request carries at least the priority of each author in terms of the target knowledge content.

In this step, the electronic device receives a distribution request sent by each author of the target knowledge content for the target knowledge content, where the distribution request carries at least the priority of each author in terms of the target knowledge content. In an embodiment, the electronic device performs identification based on the received distribution request so that the priority of each author in terms of the target knowledge content is identified in the distribution request. In a specific implementation, each author of the target knowledge content may also pay the distribution fee in advance to a knowledge content distribution platform. Then the knowledge content distribution platform determines the priority of each author in terms of the target knowledge content based on the distribution fee paid by each author. Moreover, the knowledge content distribution platform may also determine the priority of each author in terms of the target knowledge content based on factors including author levels, scores or VIP.

In S302, the target knowledge content produced by each author is stored in a pre-constructed knowledge content database according to the priority of each author of the target knowledge content in terms of the target knowledge content.

In S303, an acquisition request sent by a distribution waiting user for the target knowledge content is received, where the acquisition request carries at least an identifier of the target knowledge content.

In S304, in response to the acquisition request, the target knowledge content is searched for in the knowledge content database based on the identifier of the target knowledge content through a pre-trained knowledge content distribution model.

In S305, in response to finding the target knowledge content produced by at least one author in the knowledge content database, the target knowledge content is acquired according to the priority of each author among the at least one author in terms of the target knowledge content.

In S306, the target knowledge content is distributed to the distribution waiting user.

In S307, a feedback request sent by the distribution waiting user for the target knowledge content is received, where the feedback request carries at least the identifier of the target knowledge content.

In this step, the electronic device receives a feedback request sent by the distribution waiting user for the target knowledge content, where the feedback request carries at least the identifier of the target knowledge content. In an embodiment, the electronic device performs identification for the received feedback request so that the identifier of the target knowledge content carried in the feedback request is identified in the feedback request. In a specific implementation, each author feeds a distribution result back to the knowledge content distribution platform regularly or irregularly, and then the knowledge content distribution platform adjusts the knowledge content distribution model based on the distribution result fed back by each author. Therefore, the knowledge content database is in the dynamically adjusting and traffic updating state, improving the efficiency of distribution display and the efficiency of distribution payment.

In S308, in response to the feedback request, the knowledge content distribution model is adjusted based on the identifier of the target knowledge content to obtain an adjusted knowledge content distribution model; and the knowledge content distribution model is replaced with the adjusted knowledge content distribution model.

In this step, in response to the feedback request, the electronic device adjusts the knowledge content distribution model based on the identifier of the target knowledge content to obtain an adjusted knowledge content distribution model and replaces the knowledge content distribution model with the adjusted knowledge content distribution model. In an embodiment, the electronic device adjusts related parameters in the knowledge content distribution model to obtain the adjusted knowledge content distribution model. By adjusting related parameters in the knowledge content distribution model, the electronic device adjusts the priority of each author so that the knowledge content database is in the dynamically adjusting and traffic updating state, guaranteeing the coverage of document knowledge and ensuring more display of a document of the author with a higher priority. In the present application, an automatic and adjustable model is established by establishing a system of document content distribution and referring to the related content data of corresponding distribution; the document-converted payment after the distribution is continuously optimized through training data; and finally, a distribution mechanism mainly based on the content of high quality is achieved. Accordingly, the post-conversion payment is implemented; the spread of knowledge content is widened; and the cost for an author reaching a user is reduced. Additionally, based on the existing paid documents, VIP documents are added for distribution. In the case where a paid document is not displayed, a VIP document is supplemented for display. The arrangement in which two different product types and different payment types of products complement each other for display and payment acquisition helps establish a complete product display mechanism.

In the knowledge content distribution method provided in embodiments of the present disclosure, an acquisition request sent by a distribution waiting user for target knowledge content is received first, where the acquisition request carries at least an identifier of the target knowledge content; then in response to the acquisition request, the target knowledge content is acquired according to the priority of each author of the target knowledge content in terms of the target knowledge content; and then the target knowledge content is distributed to the distribution waiting user. That is, in the present application, the target knowledge content is acquired according to the priority of each author of the target knowledge content in terms of the target knowledge content so that the acquired target knowledge content is distributed to the distribution waiting user. In comparison, in the content distribution methods in the related art, the manner of natural distribution is usually adopted without distinguishing different authors of the same knowledge content. The present application adopts the technical means of acquiring the target knowledge content according to the priority of each author of the target knowledge content in terms of the target knowledge content and thus overcomes technical problems of the knowledge content distribution methods in the related art, including no accurate and efficient distribution manner for connecting a user and an author producing knowledge, a relatively simple recommendation strategy, and sole dependence on natural distribution for an author acquiring traffic. Embodiments of the present application provide an accurate and efficient distribution manner for connecting a user and an author producing knowledge to ensure that the user acquires the knowledge content of high quality and high correlation and that the author producing the knowledge makes the high profit. Moreover, the technical solutions in embodiments of the present application are simply and conveniently implemented, easily popularized, and more widely applied.

### Embodiment Four

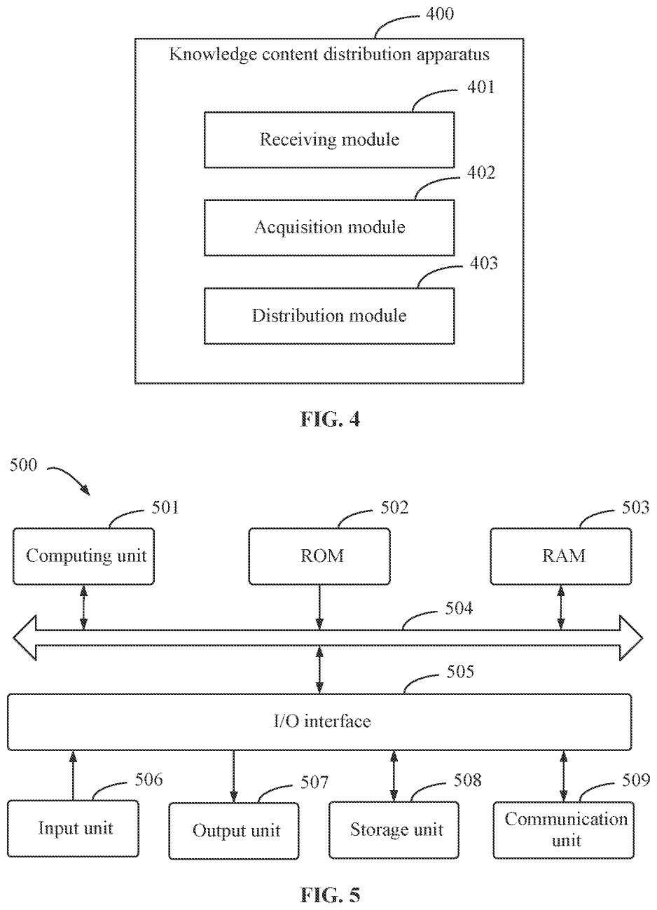

FIG. 4 is a structure diagram illustrating a knowledge content distribution apparatus according to an embodiment of the present application. As shown in FIG. 4, the apparatus 400 includes a receiving module 401, an acquisition module 402 and a distribution module 403.

The receiving module 401 is configured to receive an acquisition request sent by a distribution waiting user for target knowledge content, where the acquisition request carries at least an identifier of the target knowledge content.

The acquisition module 402 is configured to, in response to the acquisition request, acquire the target knowledge content according to the priority of each author of the target knowledge content in terms of the target knowledge content.

The distribution module 403 is configured to distribute the target knowledge content to the distribution waiting user.

In an embodiment, the apparatus further includes a storage module.

The receiving module 401 is further configured to receive a distribution request sent by each author of the target knowledge content for the target knowledge content, where the distribution request carries at least the priority of each author in terms of the target knowledge content.

The storage module is configured to store the target knowledge content produced by each author in a pre-constructed knowledge content database according to the priority of each author of the target knowledge content in terms of the target knowledge content.

In an embodiment, the acquisition module 402 is configured to search for the target knowledge content in the knowledge content database based on the identifier of the target knowledge content through a pre-trained knowledge content distribution model and, in response to finding the target knowledge content produced by at least one author in the knowledge content database, acquire the target knowledge content according to the priority of each author among the at least one author in terms of the target knowledge content.

In an embodiment, the apparatus further includes an adjustment module.

The receiving module 401 is further configured to receive a feedback request sent by the distribution waiting user for the target knowledge content, where the feedback request carries at least the identifier of the target knowledge content.

The adjustment module is configured to, in response to the feedback request, adjust the knowledge content distribution model based on the identifier of the target knowledge content to obtain an adjusted knowledge content distribution model and is configured to replace the knowledge content distribution model with the adjusted knowledge content distribution model.

In an embodiment, the distribution module 403 is further configured to, in response to the acquisition request, acquire the knowledge content associated with the target knowledge content according to the priority of each author of the target knowledge content in terms of the target knowledge content and distribute the knowledge content associated with the target knowledge content to the distribution waiting user.

In an embodiment, the distribution module 403 is configured to sort, according to the priority of each author of the target knowledge content in terms of the target knowledge content, target knowledge content produced by all authors, so as to obtain the sorted target knowledge content and is configured to display the sorted target knowledge content to the distribution waiting user.

The preceding knowledge content distribution apparatus can execute the method provided in any embodiment of the present application and has functional modules and beneficial effects corresponding to the execution method. For technical details not described in detail in this embodiment, reference may be made to the knowledge content distribution method provided in any embodiment of the present application.

In the technical solutions in the present disclosure, acquisition, storage and application of user personal information involved are in compliance with relevant laws and regulations and do not violate the public order and good customs.

### Embodiment Five

According to embodiments of the present disclosure, the present disclosure further provides an electronic device, a readable storage medium and a computer program product.

FIG. 5 is a block diagram of an exemplary electronic device 500 that may be configured to implement embodiments of the present disclosure. Electronic devices are intended to represent various forms of digital computers, for example, laptop computers, desktop computers, worktables, personal digital assistants, servers, blade servers, mainframe computers and other applicable computers. Electronic devices may further represent various forms of mobile apparatuses, for example, personal digital assistants, cellphones, smartphones, wearable devices and other similar computing apparatuses. Herein the shown components, the connections and relationships between these components, and the functions of these components are illustrative only and are not intended to limit the implementation of the present disclosure as described and/or claimed herein.

As shown in FIG. 5, the device 500 includes a computing unit 501. The computing unit 501 may perform various types of appropriate operations and processing based on a computer program stored in a read-only memory (ROM) 502 or a computer program loaded from a storage unit 508 to a random-access memory (RAM) 503. Various programs and data required for operations of the device 500 may also be stored in the RAM 503. The computing unit 501, the ROM 502 and the RAM 503 are connected to each other through a bus 504. An input/output (I/O) interface 505 is also connected to the bus 504.

A plurality of components in the device 500 are connected to the I/O interface 505. The components include an input unit 506 such as a keyboard and a mouse, an output unit 507 such as various types of displays and speakers, the storage unit 508 such as a magnetic disk and an optical disk, and a communication unit 509 such as a network card, a modem and a wireless communication transceiver. The communication unit 509 allows the device 500 to exchange information/data with other devices over a computer network such as the Internet and/or various telecommunications networks.

The computing unit 501 may be various general-purpose and/or dedicated processing components having processing and computing capabilities. Some examples of the computing unit 501 include, but are not limited to, central processing units (CPUs), graphics processing units (GPUs), various dedicated artificial intelligence (AI) computing chips, various computing units running machine learning models and algorithms, digital signal processors (DSPs), and any suitable processors, controllers and microcontrollers. The computing unit 501 executes each preceding method and processing, such as a knowledge content distribution method. For example, in some embodiments, the knowledge content distribution method may be implemented as a computer software program tangibly contained in a machine-readable medium such as the storage unit 508. In some embodiments, part or all of the computer program may be loaded and/or installed on the device 500 via the ROM 502 and/or the communication unit 509. When the computer program is loaded to the RAM 503 and executed by the computing unit 501, one or more steps of the preceding knowledge content distribution method may be executed. Alternatively, in other embodiments, the computing unit 501 may be configured, in any other suitable manner (for example, by means of firmware), to execute the knowledge content distribution method.

Herein various embodiments of the systems and technologies described above may be implemented in digital electronic circuitry, integrated circuitry, field-programmable gate arrays (FPGAs), application-specific integrated circuits (ASICs), application-specific standard products (ASSPs), systems on chips (SOCs), complex programmable logic devices (CPLDs), computer hardware, firmware, software and/or combinations thereof. The various embodiments may include implementations in one or more computer programs. The one or more computer programs are executable and/or interpretable on a programmable system including at least one programmable processor. The programmable processor may be a dedicated or general-purpose programmable processor for receiving data and instructions from a memory system, at least one input apparatus and at least one output apparatus and transmitting the data and instructions to the memory system, the at least one input apparatus and the at least one output apparatus.

Program codes for implementing the methods of the present disclosure may be compiled in any combination of one or more programming languages. The program codes may be provided for the processor or controller of a general-purpose computer, a special-purpose computer or another programmable data processing apparatus to enable functions/operations specified in a flowchart and/or a block diagram to be implemented when the program codes are executed by the processor or controller. The program codes may be executed in whole on a machine, executed in part on a machine, executed, as a stand-alone software package, in part on a machine and in part on a remote machine, or executed in whole on a remote machine or a server.

In the context of the present disclosure, a machine-readable medium may be a tangible medium that may include or store a program that is used by or in conjunction with a system, apparatus or device that executes instructions. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM), a flash memory, an optical fiber, a portable compact disk read-only memory (CD-ROM), an optical memory device, a magnetic memory device, or any suitable combination thereof.

In order that interaction with a user is provided, the systems and techniques described herein may be implemented on a computer. The computer has a display device (for example, a cathode-ray tube (CRT) or a liquid-crystal display (LCD) monitor) for displaying information to the user and a keyboard and a pointing device (for example, a mouse or a trackball) through which the user can provide input to the computer. Other types of apparatuses may also be used for providing interaction with a user. For example, feedback provided for the user may be sensory feedback in any form (for example, visual feedback, auditory feedback or haptic feedback). Moreover, input from the user may be received in any form (including acoustic input, voice input or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein) or a computing system including any combination of such back-end, middleware or front-end components. Components of a system may be interconnected by any form or medium of digital data communication (for example, a communication network). Examples of the communication network include a local area network (LAN), a wide area network (WAN) and the Internet.

The computing system may include clients and servers. The clients and servers are usually far away from each other and generally interact through the communication network. The relationship between the client and the server arises by virtue of computer programs running on respective computers and having a client-server relationship to each other. The server may be a cloud server, a server of a distributed system or a server combined with block chain.

It is to be understood that various forms of the preceding flows may be used, with steps reordered, added or removed. For example, the steps described in the present disclosure may be executed in parallel, in sequence or in a different order as long as the desired result of the technical solutions disclosed in the present disclosure is achieved. The execution sequence of these steps is not limited herein.

The scope of the present disclosure is not limited to the preceding embodiments. It is to be understood by those skilled in the art that various modifications, combinations, sub-combinations and substitutions may be made depending on design requirements and other factors. Any modifications, equivalent substitutions, improvements and the like made within the spirit and principle of the present disclosure are within the scope of the present disclosure.

What is claimed is:

1. A knowledge content distribution method, comprising:
receiving an acquisition request sent by a distribution waiting user for target knowledge content, wherein the acquisition request carries at least an identifier of the target knowledge content;
in response to the acquisition request, acquiring the target knowledge content according to a priority of each author of the target knowledge content in terms of the target knowledge content; and
distributing the target knowledge content to the distribution waiting user.

2. The method according to claim 1, before receiving the acquisition request sent by the distribution waiting user for the target knowledge content, the method further comprising:
receiving a distribution request sent by the each author of the target knowledge content for the target knowledge content, wherein the distribution request carries at least the priority of the each author in terms of the target knowledge content; and
storing the target knowledge content produced by the each author in a pre-constructed knowledge content database according to the priority of the each author of the target knowledge content in terms of the target knowledge content.

3. The method according to claim 2, wherein acquiring the target knowledge content according to the priority of the each author of the target knowledge content in terms of the target knowledge content comprises:
searching for the target knowledge content in the knowledge content database based on the identifier of the target knowledge content through a pre-trained knowledge content distribution model; and
in response to finding the target knowledge content produced by at least one author in the knowledge content database, acquiring the target knowledge content according to a priority of each author among the at least one author in terms of the target knowledge content.

4. The method according to claim 3, further comprising:
receiving a feedback request sent by the distribution waiting user for the target knowledge content, wherein the feedback request carries at least the identifier of the target knowledge content; and
in response to the feedback request, adjusting the knowledge content distribution model based on the identifier of the target knowledge content to obtain an adjusted knowledge content distribution model; and replacing the knowledge content distribution model with the adjusted knowledge content distribution model.

5. The method according to claim 1, further comprising:
in response to the acquisition request, acquiring knowledge content associated with the target knowledge content according to the priority of the each author of the target knowledge content in terms of the target knowledge content; and
distributing the knowledge content associated with the target knowledge content to the distribution waiting user.

6. The method according to claim 1, wherein distributing the target knowledge content to the distribution waiting user comprises:
sorting, according to the priority of the each author of the target knowledge content in terms of the target knowledge content, target knowledge content produced by all authors, so as to obtain sorted target knowledge content; and
displaying the sorted target knowledge content to the distribution waiting user.

7. An electronic device, comprising:
at least one processor; and
a memory communicatively connected to the at least one processor;
wherein the memory stores instructions executable by the at least one processor, and the instructions are executed by the at least one processor to cause the at least one processor to perform the following steps:
receiving an acquisition request sent by a distribution waiting user for target knowledge content, wherein the acquisition request carries at least an identifier of the target knowledge content;
in response to the acquisition request, acquiring the target knowledge content according to a priority of each author of the target knowledge content in terms of the target knowledge content; and
distributing the target knowledge content to the distribution waiting user.

8. The electronic device according to claim 7, wherein the instructions are further executed by the at least one processor to cause the at least one processor to perform, before receiving the acquisition request sent by the distribution waiting user for the target knowledge content, the following steps:
receiving a distribution request sent by the each author of the target knowledge content for the target knowledge content, wherein the distribution request carries at least the priority of the each author in terms of the target knowledge content; and
storing the target knowledge content produced by the each author in a pre-constructed knowledge content database according to the priority of the each author of the target knowledge content in terms of the target knowledge content.

9. The electronic device according to claim 8, wherein the acquiring the target knowledge content according to the priority of the each author of the target knowledge content in terms of the target knowledge content comprises:
searching for the target knowledge content in the knowledge content database based on the identifier of the target knowledge content through a pre-trained knowledge content distribution model; and
in response to finding the target knowledge content produced by at least one author in the knowledge content database, acquiring the target knowledge content according to a priority of each author among the at least one author in terms of the target knowledge content.

10. The electronic device according to claim 9, wherein the instructions are further executed by the at least one processor to cause the at least one processor to perform the following steps:
receiving a feedback request sent by the distribution waiting user for the target knowledge content, wherein the feedback request carries at least the identifier of the target knowledge content; and
in response to the feedback request, adjusting the knowledge content distribution model based on the identifier of the target knowledge content to obtain an adjusted knowledge content distribution model; and replacing the knowledge content distribution model with the adjusted knowledge content distribution model.

11. The electronic device according to claim 7, wherein the instructions are further executed by the at least one processor to cause the at least one processor to perform the following steps:
in response to the acquisition request, acquiring knowledge content associated with the target knowledge content according to the priority of the each author of the target knowledge content in terms of the target knowledge content; and
distributing the knowledge content associated with the target knowledge content to the distribution waiting user.

12. The electronic device according to claim 7, wherein the distributing the target knowledge content to the distribution waiting user comprises:
sorting, according to the priority of the each author of the target knowledge content in terms of the target knowledge content, target knowledge content produced by all authors, so as to obtain sorted target knowledge content; and
displaying the sorted target knowledge content to the distribution waiting user.

13. A non-transitory computer-readable storage medium, the storage medium storing computer instructions, wherein the computer instructions are configured to cause a computer to perform the following steps:
receiving an acquisition request sent by a distribution waiting user for target knowledge content, wherein the acquisition request carries at least an identifier of the target knowledge content;
in response to the acquisition request, acquiring the target knowledge content according to a priority of each author of the target knowledge content in terms of the target knowledge content; and
distributing the target knowledge content to the distribution waiting user.

14. The storage medium according to claim 13, wherein the computer instructions are further configured to cause the computer to perform, before receiving the acquisition request sent by the distribution waiting user for the target knowledge content, the following steps:
receiving a distribution request sent by the each author of the target knowledge content for the target knowledge content, wherein the distribution request carries at least the priority of the each author in terms of the target knowledge content; and
storing the target knowledge content produced by the each author in a pre-constructed knowledge content database according to the priority of the each author of the target knowledge content in terms of the target knowledge content.

15. The storage medium according to claim 14, wherein the acquiring the target knowledge content according to the priority of the each author of the target knowledge content in terms of the target knowledge content comprises:
searching for the target knowledge content in the knowledge content database based on the identifier of the target knowledge content through a pre-trained knowledge content distribution model; and
in response to finding the target knowledge content produced by at least one author in the knowledge content database, acquiring the target knowledge content according to a priority of each author among the at least one author in terms of the target knowledge content.

16. The storage medium according to claim 15, wherein the computer instructions are further configured to cause the computer to perform the following steps:
receiving a feedback request sent by the distribution waiting user for the target knowledge content, wherein the feedback request carries at least the identifier of the target knowledge content; and
in response to the feedback request, adjusting the knowledge content distribution model based on the identifier of the target knowledge content to obtain an adjusted knowledge content distribution model; and replacing the knowledge content distribution model with the adjusted knowledge content distribution model.

17. The storage medium according to claim 13, wherein the computer instructions are further configured to cause the computer to perform the following steps:
in response to the acquisition request, acquiring knowledge content associated with the target knowledge content according to the priority of the each author of the target knowledge content in terms of the target knowledge content; and
distributing the knowledge content associated with the target knowledge content to the distribution waiting user.

18. The storage medium according to claim 13, wherein the distributing the target knowledge content to the distribution waiting user comprises:
sorting, according to the priority of the each author of the target knowledge content in terms of the target knowledge content, target knowledge content produced by all authors, so as to obtain sorted target knowledge content; and
displaying the sorted target knowledge content to the distribution waiting user.
